(19) United States
(12) Patent Application Publication
(10) Pub. No.: US 2002/0082937 A1
(43) Pub. Date: Jun. 27, 2002

(54) System and method for providing services across an electronic link

(76) Inventor: Michael Retherford, Johnston, IA (US)

Correspondence Address: BRETT J. TROUT, 300 S.W. 5TH, SUITE 222, DES MOINES, IA, 50309, US

(21) Appl. No.: 09/749,164

(22) Filed: Dec. 27, 2000

(51) Int. Cl. G06F 17/60

(52) U.S. Cl. 705/26

(57) ABSTRACT

A method for providing services to a customer across an electronic link is provided. A computer, coupled to customer and service provider databases, receives customer billing information across an electronic link, such as a global computer network. The computer associates a code with the customer, stores the code on the customer database, and transmits the code to the customer across the global computer network. The customer then contacts the computer by telephone and inputs the code. The computer receives the code from the customer and connects the customer to a service provider. The service provider may then provide professional services to the customer over the telephone. In the preferred embodiment, the service provider is an attorney, and is not an employee of said database provider.

### FIELD OF THE INVENTION

The present invention relates generally to a system for providing services across an electronic link and, more particularly, to a system for receiving billing information across a global computer network and providing professional services across a telephone line.

### BACKGROUND OF THE INVENTION

It is generally known in the art to provide professional services, such as legal advice, via telephone or other electronic means, such as electronic mail. The provision of such professional services via these types of electronic links works well for large clients having a continuing relationship with a particular service provider, or for clients involved in matters of a sufficient scale to allow the service provider to justify costs associated with opening a new case, investigating a client's credit worthiness, determining an appropriate fee arrangement, possibly obtaining a retainer, and subsequently pursuing collection of fees billed.

However, for clients not involved in an ongoing relationship with a particular service provider, or for clients involved in small-scale matters, it is often difficult to obtain low cost responsive service. Many services providers decline representation in such cases, opting not to invest fee arrangement and collection time in matters which may only involve telephonic advice. Often in such cases, collection costs outweigh the amount of the fees billed.

From the prospective of the service provider, it would be desirable to employ a screening process to reduce the number of slow-pay and no-pay customers. It would also be desirable to provide a steady stream of new clients, without the necessity of a large advertising budget.

From the customer prospective, it would be desirable to screen service providers to insure an acceptable level of quality in services provided. It would also be desirable to reduce the number of service providers unwilling to accept a particular case. This would allow clients access to service provider for matters which may otherwise be difficult to encourage a service provider to accept. It would additionally be advantageous for a client to allow for standardized payment mechanisms, such as a credit card, and to receive services on in an expedited manner to prevent the gravity of the matter from increasing due to a failure to obtain a timely remedy. The difficulties encountered in the prior art discussed hereinabove are substantially eliminated by the present invention.

### SUMMARY OF THE INVENTION

In an advantage provided by this invention, a method is provided for providing professional services which reduces the amount of time required by a service provider to provide services in response to a customer inquiry.

Advantageously, this invention provides a screening process to assist service providers in recovering fees from customers.

Advantageously, this invention provides a means for increasing revenue for service providers.

Advantageously, in a preferred example of this invention, a method for providing professional services to a customer is provided, comprising providing a computer upon which is provided a database. The method further includes the steps of receiving customer billing information across a first electronic link, associating a code with the customer, storing the code on the database, transmitting the code to the customer across a second electronic link, receiving the code from the customer across a third electronic link, and providing the services from a service provider to the customer responsive to receiving the code from the customer.

### BRIEF DESCRIPTION OF THE DRAWINGS

The invention will now be described, by way of example, with reference to the accompanying drawings in which:

FIG. 1 is a block diagram illustrating the preferred embodiment of the present invention;

FIG. 2A illustrates a web page incorporating the Customer Agreement of the present invention;

FIG. 2B illustrates a web page listing the types of professional services offered to the customer;

FIG. 2C illustrates a web page prompting the customer to input billing information;

FIG. 2D illustrates a web page providing the customer with the customer code and the telephone number to obtain professional services;

FIG. 3 illustrates a telephone keypad of the present invention;

FIG. 4 illustrates a portion of an exemplary customer information database;

FIG. 5 illustrates a portion of an exemplary service provider information database;

FIGS. 6A-6C illustrate a flowchart of an exemplary process for providing professional services from a professional service provider to a customer according to the present invention.

FIG. 7 illustrates an exemplary electronic mail message used to determine availability of a service provider.

### DETAILED DESCRIPTION OF THE PREFERRED EMBODIMENT

The Internet comprises millions of computers and computer networks, interconnected to one another for the exchange of information via many avenues, including the World Wide Web (“the Web”). The Web allows a server to send graphical information (“Web Pages”) to a remote computer, which the remote computer can then display using a “browser”. A user of the remote computer can access Web Pages either through a search engine or by using a mouse or similar pointing device to “click” a “hyperlink” comprising hypertext markup language (“HTML”). A hyperlink contained within a particular Web Page allows a user of a remote computer to display an alternate Web Page. When clicked, the hyperlink identifies the location of the desired Web Page and prompts a server to send that information to the user for display.

The present invention provides a method for allowing a customer to utilize the Web, or similar computer network, to quickly obtain services from a professional service provider. The method facilitates the provision of services, for both the professional service provider and customer, by obtaining billing information from the customer and pre-selecting the professional service provider for a standard level of quality.

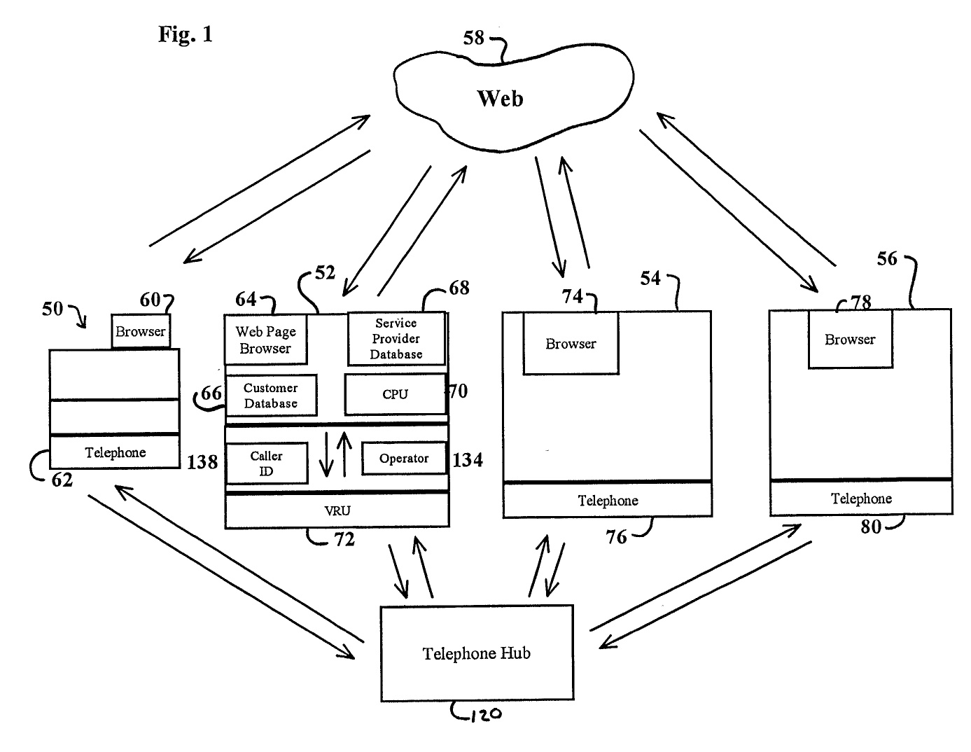

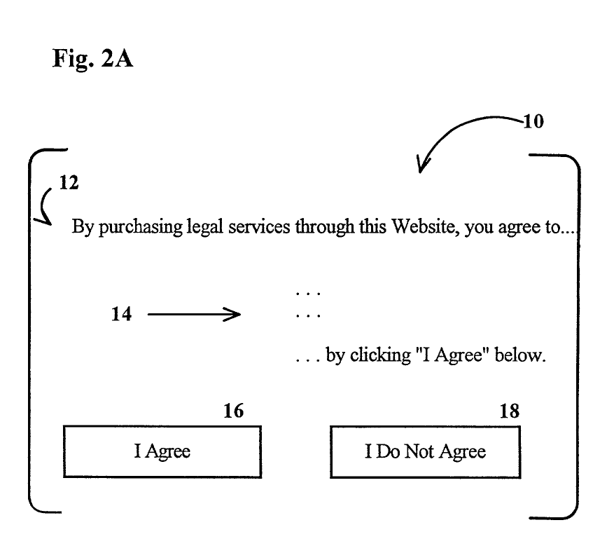

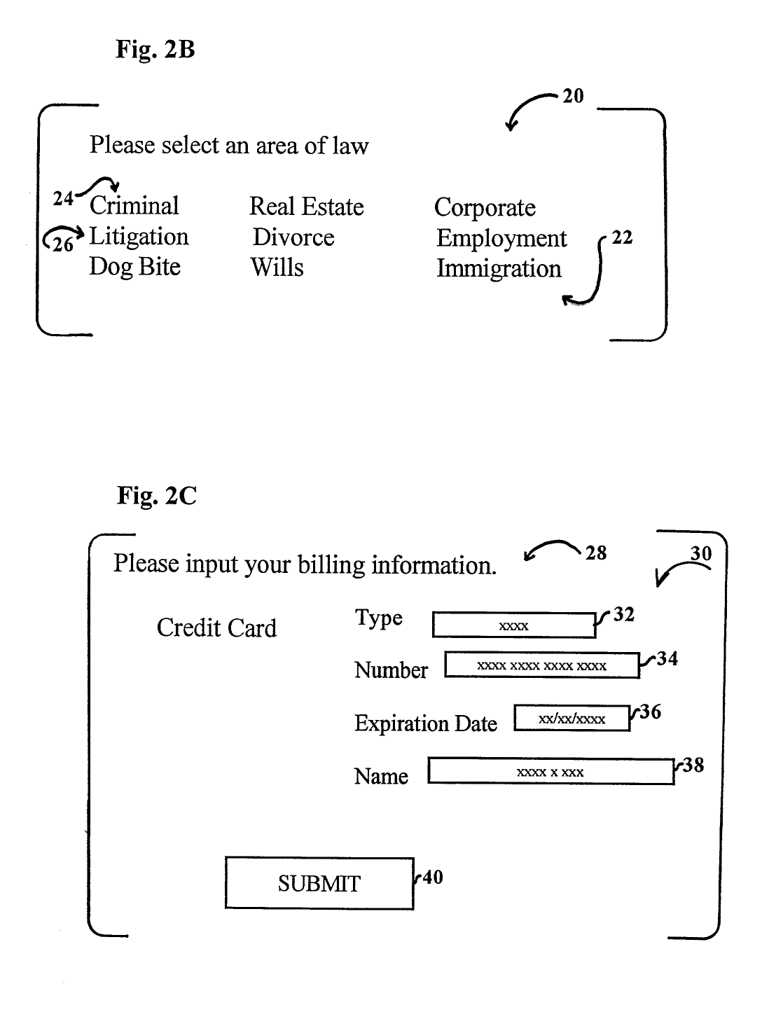

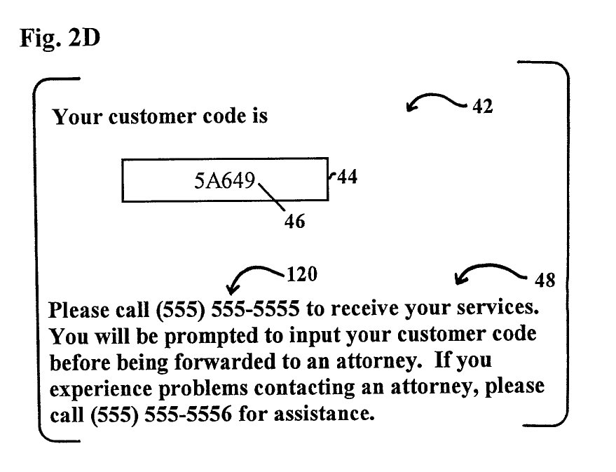

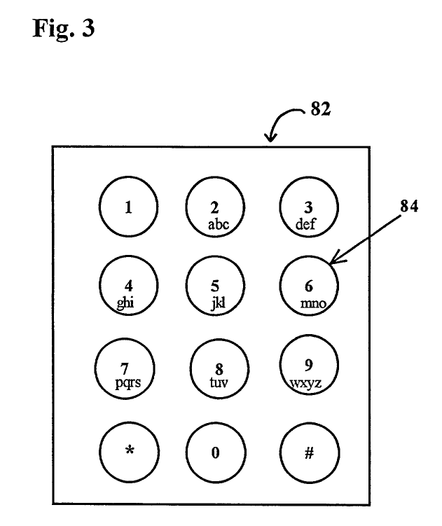

FIG. 1 illustrates a block diagram of the method anticipated by the present invention. FIGS. 2A-2D illustrate Web pages utilized by the method. FIG. 2A illustrates an introductory Web Page (10) describing a legal agreement (12). The legal agreement (12) comprises a body (14), as well as an “I agree” button (16) and an “I do not agree” button (18). Although the body (14) of the agreement may be any type agreement known in the art, in the preferred embodiment, the body (14) contains specific language which binds a customer to the terms of the body (14) of the agreement (12) upon the customer actuating the “I agree” button (16). Additionally, in the preferred embodiment, the “I agree” button (16) and “I do not agree” button (18), or just the “I agree” button (16) are coded in HTML to “link” to the Uniform Resource Locator (URL) of another Web Page, so as to direct a customer to that Web Page upon the customer clicking on button (16) or (18).

FIG. 2B illustrates a Selection Web Page (20), including a plurality of hyperlinks (22). These hyperlinks (22) are coded in HTML to allow a customer to obtain content for an alternate Web Page upon clicking on the hyperlink (22). As shown in FIG. 2B, the Selection Web Page (20) includes at least a first hyperlink (24) and a second hyperlink (26). In the preferred embodiment, the hyperlinks (22) are associated with various areas of the law, but may, of course, be associated with any type of professional services.

Shown in FIG. 2C is an Input Web Page (28). The Input Web Page (28) includes a plurality of fields (30) for inputting a customer's billing information, which may include a type field (32), a number field (34), an expiration date field (36), and a name field (38). The Input Web Page (28) also includes a “Submit” button (40), preferably coded in HTML to send the inputted information. FIG. 2D illustrates a Code Web Page (42), including a code field (44) containing the customer code (46). The Code Web Page (42) also includes instructions (48) detailing use of the customer code (46) to obtain professional services.

FIG. 1 illustrates the transfer of information between the customer (50), the server (52), a service provider (54) and a alternate service provider (56), which are all connected to the Web (58), or a similar network, by wired and/or wireless means known in the art. As shown in FIG. 1, the customer (50) includes a browser (60) such as those well known in the art, for communication via the Web (58). Additionally, the customer (50) includes a telephone (62). The server (52) includes a browser (64), a customer database (66), and a service provider database (68), all coupled to a central processing unit (70). The central processing unit may be a personal computer or any type of processing unit known in the art. The server (52) also includes a voice response unit (72) coupled to the central processing unit (70).

As shown in FIG. 1, the service provider (54) includes a browser (74) coupled to the Web (58) and also includes a telephone (76). Similarly, the alternate service provider (56) includes a browser (78) coupled to the Web (58), and includes a telephone (80). Although the customer telephone (62) may be of any type known in the art, in the preferred embodiment the telephone (62) is provided with a keypad (82), provided with buttons (84) designed alphanumerically to allow the input of a code into the keypad (82). (FIGS. 1 and 3).

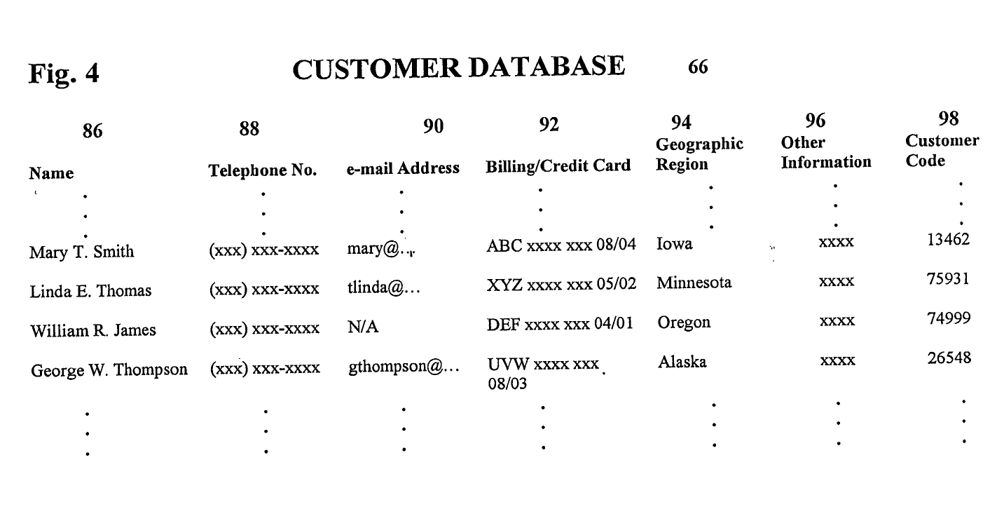

The customer database (66), as shown in FIG. 4, includes fields for the customer name (86), telephone number (88), electronic mail address (90), billing information (92), geographic region (94), and other information (96) relating to the customer (50). (FIGS. 1 and 4). The other information (96) may include confidential and/or non-confidential information. The other information (96) may include information relating to the scope of services to which the customer (50) is allowed access, preferred service providers, past service issues, or any other desired information. Additionally, unique customer codes (98) are associated with each customer (50) in the customer database (66). (FIGS. 1 and 4). The server (52) may obtain customer codes (98) from a pre-selected list (not shown) from a random (ode generator (not shown) or from any other means known in the art.

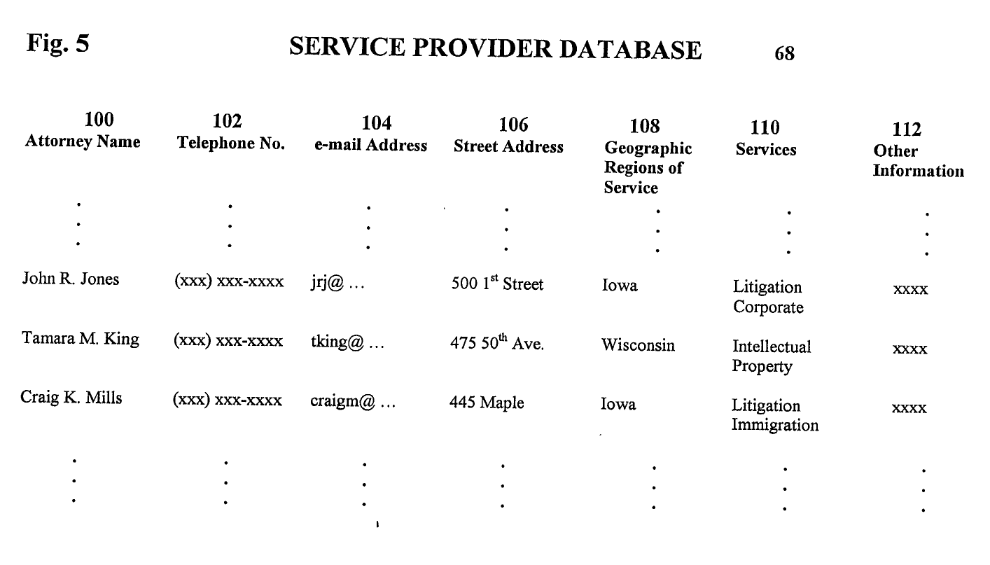

The server (42) also includes a service provider database (68). (FIGS. 1 and 5). The service provider database (68) includes a list of names (100) of the service providers (54) and (56), as well as associated telephone numbers (102), electronic mail addresses (104), street addresses (106), geographic regions of practice (108), services offered (110), as well as other information (112). The other information (112) may include information relating to past customer contacts, years of experience, customer rating, hourly billing information, or any other suitable information. Although the information in FIG. 5 relates to attorneys, the service providers (54) and (56) may, of course, be physicians, accountants, financial analysts, or any other service providers. In a preferred embodiment of the present invention, the service providers (54) and (56) are attorneys, physicians, or other persons licensed to provide specialized professional services. Most preferably, the service providers (54) and (56) are licensed attorneys.

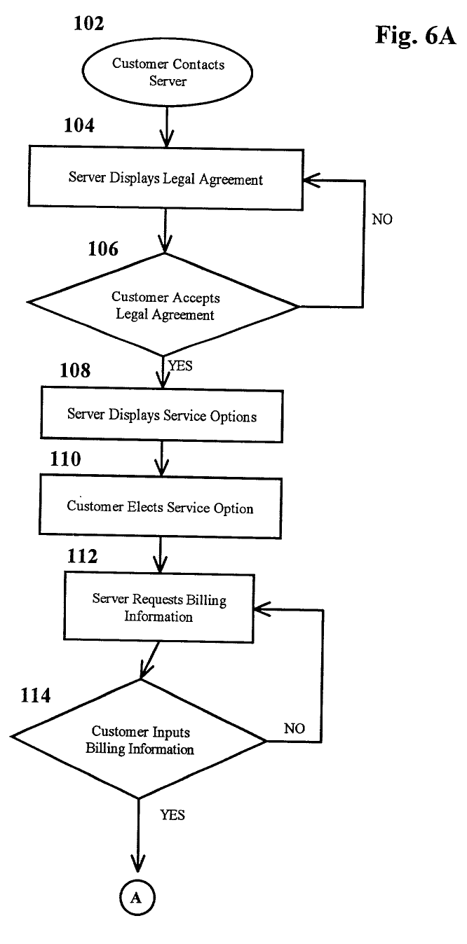

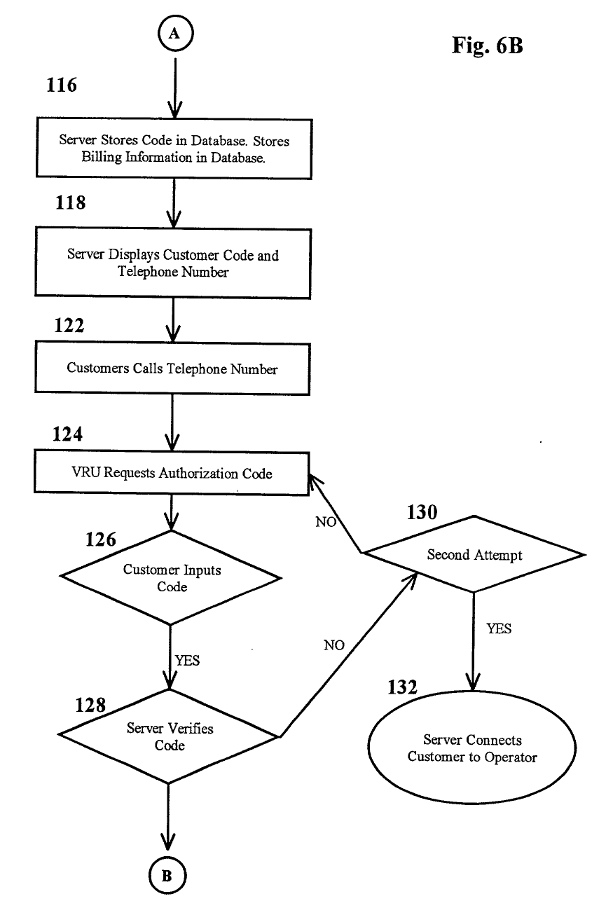

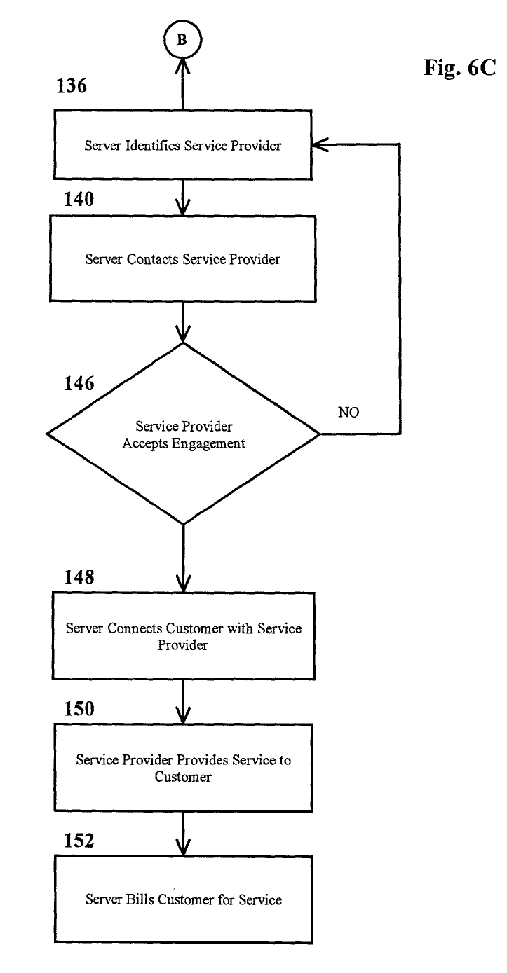

FIGS. 6A-6C are a flow diagram of the method of the present invention. As shown in Step (102), when the customer (50) desires to obtain professional services, the customer (50) utilizes the browser (60) via the Web (58), or similar network, to contact the server (52) to access the Introductory Web Page (10). (FIGS. 1, 2A and 6A). As shown in Step (104), after the customer (50) has contacted the server (52), the server (52) displays the legal agreement (12) of the Introductory Web Page (10), shown in FIG. 2A. As shown in Step (106), the customer (50) has the option of accepting the legal agreement (12) by using a pointing device (not shown) to click on either the “I agree” button (16), or the “I do not agree” button (18). If the customer (50) clicks on the “I do not agree” button (18), the server (52) redisplays the Introductory Web Page (10) until the customer (50) clicks on the “I agree” button (16), or provides the customer with an alternative “help” Web page (not shown).

As shown in FIG. 6A, if the customer (50) accepts the legal agreement (12) by clicking on the “I agree” button (16), the server (52), in Step (108), displays to the customer (50) the Selection Web Page (20) shown in FIG. 2B. (FIGS. 1, 2A-B and 6A). As shown in FIG. 2B, the Selection Web Page (20) preferably displays a plurality of service options available to the customer (50). As noted above, the service options are presented in the form of hyperlinks (22). As shown in Step (110), the customer (50) selects one of the service options by using the pointing device to click on the hyperlink (22) associated with the desired service option. For example, if the customer (50) desires professional services in the area of criminal law, the customer (50) simply uses the pointing device to click on the first hyperlink (24) associated with criminal law.

As shown in Step (112), clicking on the first hyperlink (24) actuates the server (52) to display the Input Web Page (28) to the customer (50) via the customer's browser (60). (FIGS. 1, 2B, 2C and 6A). As shown in FIG. 2C, the Input Web Page (28) prompts the customer (50) to input the customer's billing information (92) via the customer's browser (60). (FIGS. 1, 2C and 4). As shown in Step (114), if the customer (50) fails to input the billing information (92) the server (52) redisplays the Input Web Page (28) for the customer (50). (FIGS. 1, 2C, 4 and 6A). Once the customer (50) inputs the billing information (92), type field (32), number field (34), expiration date field (36) and name field (38), and clicks on the submit button (40), the server (52) obtains the customer code (46) either through a random number generation process or similar means known in the art. As shown in Step (116), the server (52) stores the billing information (92) on the customer database (66). (FIGS. 1, 4, and 6B). In addition to the billing information (92), the server (52) may also request additional information from the customer (50), such as the customer's name (86), telephone number (88), electronic mail address (90), geographic region (94), or any other desired information (96) which the server (52) may thereafter also store in the customer database (66).

As shown in Step (118), the server (52) displays the customer code to the customer (50) in the form of the Code Web Page (42) shown in FIG. 2D. (FIGS. 1, 2D and 6B). The Code Web Page (42) provides the customer (50) with not only the customer code (46) to obtain professional services, but also the instructions (48) for utilizing the customer code (46). As shown in FIG. 2D, these instructions (48) instruct the customer (50) to dial a pre-designated telephone number. The instructions (48) prompt the customer to input the customer code (46), utilizing the keypad (82) of the customer's telephone (62). (FIGS. 1, 2D, 3 and 6B). The customer (50) uses the telephone (62) to connect to the server (52) via a standard telephony hub (120), such as those known in the art, representing Step 122 in the present method.

As shown in Step (124), upon receipt of the customer's call, the server's voice response unit (72), also coupled to the telephony hub (120), requests that the customer (50) input the customer code (46) using the keypad (82) of the customer's telephone (62). (FIGS. 1, 3, and 6B). In Step (126), the customer (50) inputs the code (46) which the server (52) attempts to verify in Step (128). If the server (52) fails to verify the customer code (46) after a second attempt, as shown in Step (130), the process moves to Step (132), where the server (52) connects the custom (50) to a help line operator (134) associated with the server (52). The operator (134) may be any type of operator known in the art, including a human operator or a standard voice response unit which requests the customer (50) enter additional information to either obtain the authorized code (46), or be issued an alternative code. As shown in Step (130), if it is not the second attempt to verify the code, the process moves back to Step (124) where the voice response unit (72) again requests the customer code (46) from the customer (50).

Once the server (52) verifies the customer code (46), the server (52), in Step (136) accesses the service provider database (68) to obtain the name (100) of a service provider (54). (FIGS. 1, 5 and 6C). The service provider (54) may either be randomly chosen for a particular trait identified in the service provider database (68), or may be chosen based upon an alternative criteria. The server (52) may be even utilize a caller identification system (138) associated with the server (52), such as those well known in the art, to match the customer (50) with a service provider (54) having an area code or prefix similar to that of the customer (50). Preferably, at least one of the criteria used to select the service provider (54) is the service criteria identified from the Selection Web Page (20) in response to the customer (50) clicking on the hyperlink (22) associated with the desired service criteria.

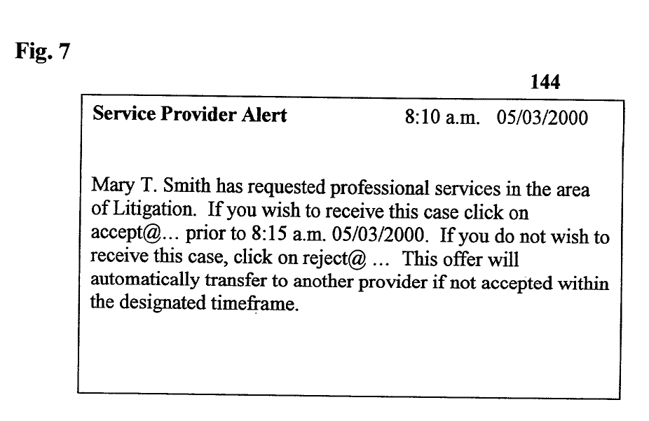

The server (52) may directly connect the customer (50) to the service provider (54), prior to identification of the availablity of the service provider (54). (FIG. 1). In the preferred embodiment, however, as shown in Step (140), the server (52) first contacts the service provider (54) to determine availability. (FIGS. 1 and 6C). Although the server (52) may contact the service provider (54) by any means known in the art, in the preferred embodiment the server (52) contacts the service provider (54) via the voice response unit (72) programmed with a message to determine availability, via an electronic message generator (142). The server (52) may, of course, contact the service provider via electronic mail or other electronic communication means, such as those known in the art. (FIGS. 1, 6C and 7). If the server (52) uses electronic mail to contact the service provider (54), the server (52) may utilize an electronic message generator (142) to generate and forward an electronic message (144), such as that shown in FIG. 7, to the service provider (54) to determine availability.

As shown in Step (146), if, in response to the request for availability from the server (52), the service provider (54) does not accept the engagement, either by failing to respond to the server (52) or responding negatively to the server (52), the process returns to Step (136). (FIGS. 1 and 6C). As shown in Step (136), the server (52) thereafter selects an alternate service provider (56) from the service provider database (68). The server (52) then sends the alternate service provider (56) a voice message or an electronic message (144) to determine the availability of the alternate service provider. Once either the service provider (54) or the alternate service provider (56) accepts the engagement, as shown in Step (148), the server (52) connects the customer (50) with the service provider (54) by a telephonic link, utilizing the telephony hub, or any similar connection known in the art. As shown in Step (150), the service provider (54) provides services to the customer (50) via the telephony hub (120). As shown in Step (152), the server (52) bills the customer (50) for the services provided. Additionally, after the services have been provided, the server (52) may update the customer database (66), service provider database (68), or other database with information regarding the services provided, such as type of service provided, dates service was requested, date service was provided, the amount the customer was billed, whether payment was received, or customer satisfaction with the services provided.

The foregoing description and drawings merely explain and illustrate the invention, and the invention is not limited thereto, except insofar as the claims are so limited, as those skilled in the art who have the disclosure before them will be able to make modifications and variations therein, without departing from the scope of the invention. For example, it is anticipated that the steps identified in FIGS. 6A-6C may be implemented in any desired order, and that the links between the customer (50), server (52) and service provider (54) may be implemented telephonically, via the Web, via video conferencing, or via any suitable communication link.

What is claimed is:

1. A method for providing services to a customer comprising:
(a) providing a computer;
(b) providing a database on said computer;
(c) receiving customer billing information across a first electronic link;
(d) associating a code with said customer;
(e) storing said code on said database;
(f) transmitting said code to said customer across a second electronic link;
(g) receiving said code from said customer across a third electronic link; and
(h) providing services from a service provider to said customer responsive to receiving said code from said customer.

2. The method of claim 1, wherein said service provider is an attorney.

3. The method of claim 1, wherein said service provider is a physician.

4. The method of claim 1, wherein said database is owned by a database provider, and wherein said service provider is not an employee of said database provider.

5. The method of claim 1, wherein said service provider is an independent contractor.

6. The method of claim 1, wherein said service provider offers services at a standard fee and wherein said service provider offers services to said customer at a discount fee; wherein said discount fee is less than said standard fee.

7. The method of claim 1, wherein said first electronic link is a connection over a global network.

8. The method of claim 1, wherein said third electronic link is a telephone line.

9. The method of claim 1, wherein said service provider verbally provides services to the customer over a telephone.

10. The method of claim 1, further comprising the step of inputting said code by said customer into a telephone keypad, and wherein said third electronic link is a telephone line.

11. A method for providing professional services to a customer comprising:
(a) providing a computer;
(b) providing a database on said computer;
(c) transmitting customer billing information from said customer to said database across a global computer network;
(d) storing said customer billing information on said database;
(e) associating a code with said customer;
(f) transmitting said code to said customer across a global computer network;
(g) inputting said code on a telephone keypad;
(h) receiving said code from said customer across a telephone line;
(i) providing professional services to said customer responsive to receiving said code from said customer; and
(j) utilizing said billing information to bill said customer for professional services rendered.

12. The method of claim 11, further comprising the step of storing the billing information and information relating to professional services rendered on said database.

13. The method of claim 11, wherein said professional services are provided over a telephone line.

14. The method of claim 11, wherein said professional services are provided over a global computer network.

15. A method for providing services to a customer comprising:
(a) providing a computer;
(b) providing a database on said computer;
(c) providing a plurality of codes;
(d) transmitting data containing billing information of a customer from said customer to said computer across a first electronic link;
(e) associating said data with a code selected from said plurality of codes;
(f) transmitting said code to said customer across a second electronic link;
(g) transmitting said code from said customer across a third electronic link;
(h) creating a fourth electronic link between said customer and a service provider; and
(i) providing the services from said service provider to said customer across said fourth electronic link.

16. The method of claim 15, wherein said service provider is an attorney.

17. The method of claim 15, wherein said service provider is a physician.

18. The method claim 15, wherein said code and said billing information are stored on said database.

19. The method claim 15, wherein said computer and said database are owned by a database provider, and wherein said service providers are not employees of said database provider.

20. The method of claim 15, wherein said service providers are independent contractors.

21. The method of claim 15, wherein said service providers offer services at a standard fee and wherein said service providers offer services to said customer at a discount fee, wherein said discount fee is less than said standard fee.
